(19) United States
(12) Patent Application Publication
(10) Pub. No.: US 2026/0135824 A1
(43) Pub. Date: May 14, 2026

(54) METHODS, APPARATUSES AND SYSTEMS RELATED TO EDGE APPLICATION RUN-TIME RESOURCE MODIFICATION

(71) Applicant: InterDigital Patent Holdings, Inc., Wilmington, DE (US)

(72) Inventors: Robert Gazda, Spring City, PA (US); Debashish Purkayastha, Eagleville, PA (US); Kevin Di Lallo, Laval (CA); Michael Starsinic, Newtown, PA (US); Michel Roy, Candiac (CA); Ulises Olvera-Hernandez, Saint-Lazare (CA)

(21) Appl. No.: 18/947,349

(22) Filed: Nov. 14, 2024

(51) Int. Cl. H04L 47/70; H04L 67/1097

(52) U.S. Cl. CPC H04L 47/822; H04L 67/1097

(57) ABSTRACT

In an embodiment, a method implemented in a first node, comprises receiving, from a second node, an application modification request message comprising first information indicating an identity, security and trust credentials of the second network node, and an resource modification descriptor; determining an edge resource descriptor (ERD) list based on the first information of the application modification request message; transmitting, to the second node, a resource allocation request message; receiving, from the second node, a message indicating success of the resource allocation request; transmitting, to a third node, an application descriptor modification notification comprising second information indicating an identity and credentials of the first network node, and the ERD list; receiving, from the third node, an application descriptor modification acknowledgement message, comprising third information indicating a modified ERD list; and transmitting, to the second node, an application modification response message, comprising fourth information indicating the modified ERD list.

### FIELD OF THE INVENTION

The present disclosure is generally directed to methods and procedures related to an application to initiate modification, at run-time, of edge resources. More particularly the present disclosure relates to methods, apparatuses and systems for an edge/client application to initiate the modification, at run-time, of edge resources allocated for one or more edge applications to maintain overall edge application vertical performance.

### BACKGROUND

In 5G systems, edge compute resources may be commonly deployed in core network data centers. Resource scaling techniques used in cloud computing, such as over-provisioning and centralized controller modification methods, may be used to adjust edge resources in 5G systems. These methods break down and are impractical in new radio systems with highly distributed edge computation locations, including resource constrained mobile device edge nodes with limited capabilities and applications that require dynamic/run-time edge resource adjustment. In other words, these methods break down and are impractical when edge computation resources are deployed on mobile devices.

There is a need to reallocate edge resources (e.g., CPU, GPU, memory, storage, FPGA, AIML, etc.) assigned to an edge application or group of edge applications at run-time, when initiated by an edge application or an application client, in order to maintain needed application vertical performance, availability, and user-experience.

### SUMMARY

In an embodiment, a method, implemented in a first network node, may comprise a step of receiving, from a second network node, an edge application modification request message comprising first information indicating an identity of the second network node, security and trust credentials of the second network node, and an edge resource modification descriptor (ERMD). The method may further comprise a step of determining an edge resource descriptor (ERD) list based on the first information of the edge application modification request message. The method may further comprise a step of transmitting, to the second network node, a resource allocation request message. The method may further comprise a step of receiving, from the second network node, a response message indicating success of the resource allocation request. The method may further comprise a step of transmitting, to a third network node, an edge application descriptor modification notification comprising second information indicating an identity of the first network node, credentials of the first network node, and the ERD list. The method may further comprise a step of receiving, from the third network node, an edge application descriptor modification acknowledgement message, comprising third information indicating a modified ERD list; and a step of transmitting, to the second network node, an edge application modification response message, comprising fourth information indicating the modified ERD list.

The first network node may comprise an Edge Host Management Function. The second network node may comprise an Edge Application Enablement Function. The third network node may comprise an Edge System Management Function. The ERD list may comprise at least one ERD entry including an edge application performance index. The ERMD may comprise fifth information indicating an edge application vertical performance Index.

The method may further comprise a step of determining if there are sufficient edge resources to satisfy the edge application modification request based on the ERD list and based on available edge resources for the edge application on the second network node; and a step of transmitting, to the second network node, the resource allocation request message on condition that are sufficient edge resources to satisfy the edge application modification request.

The sufficient edge resources may be determined based on the comparing in total level of edge resources configured in the second network node against the level of those resources available for the edge application on the second network node.

In an embodiment, a first network node, comprising a processor, a transmitter, a receiver and a memory, may be configured to receive, from a second network node, an edge application modification request message comprising first information indicating an identity of the second network node, security and trust credentials of the second network node, and an edge resource modification descriptor (ERMD). The first network node may be configured to determine an edge resource descriptor (ERD) list based on the information of the edge application modification request message. The first network node may be configured to transmit, to the second network node, a resource allocation request message. The first network node may be configured to receive, from the second network node, a response message indicating success of the resource allocation request. The first network node may be configured to transmit, to a third network node, an edge application descriptor modification notification comprising second information indicating an identity of the first network node, credentials of the first network node, and the edge resource descriptor list. The first network node may be configured to receive, from the third network node, an edge application descriptor modification acknowledgement message, comprising third information indicating a modified ERD list; and to transmit, to the second network node, an Edge Application Modification response message, comprising fourth information indicating the modified ERD list.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a Multi-Access Edge computing concept according to an embodiment;

FIG. 3 is a block diagram illustrating an example of a Multi-Access Edge computing architecture according to an embodiment;

FIG. 4 is a block diagram illustrating an example of an edge computing in 5G System according to an embodiment;

FIG. 5 is a block diagram illustrating an example of a 5GS architecture for supporting edge computing according to an embodiment;

FIG. 6 is a block diagram illustrating an example of a 5G edge application architecture according to an embodiment;

FIG. 7 is a block diagram illustrating an example of a 5G edge computing management framework according to an embodiment;

FIG. 8 is a block diagram illustrating an example of next generation/6G edge system architecture according to an embodiment;

FIG. 9 is a block diagram illustrating an example of a functional architecture considering constrained device edge hosts, according to an embodiment;

FIG. 10 is a signalling diagram illustrating an example of an Edge Application initiated Edge Resource Run-time Modification Procedure, according to an embodiment;

FIG. 11 is a signalling diagram illustrating an example of an Application Client initiated Edge Resource Run-time Modification Procedure, according to an embodiment;

FIG. 12, is a signalling diagram illustrating an example of an Edge Application initiated Edge Resource Query Procedure, according to an embodiment;

FIG. 13 is a signalling diagram illustrating an example of an Application Client initiated Edge Resource Query Procedure; and

FIG. 14 is a flow chart diagram illustrating an example of a method, implemented in a first network node to modify edge application run-time resource.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

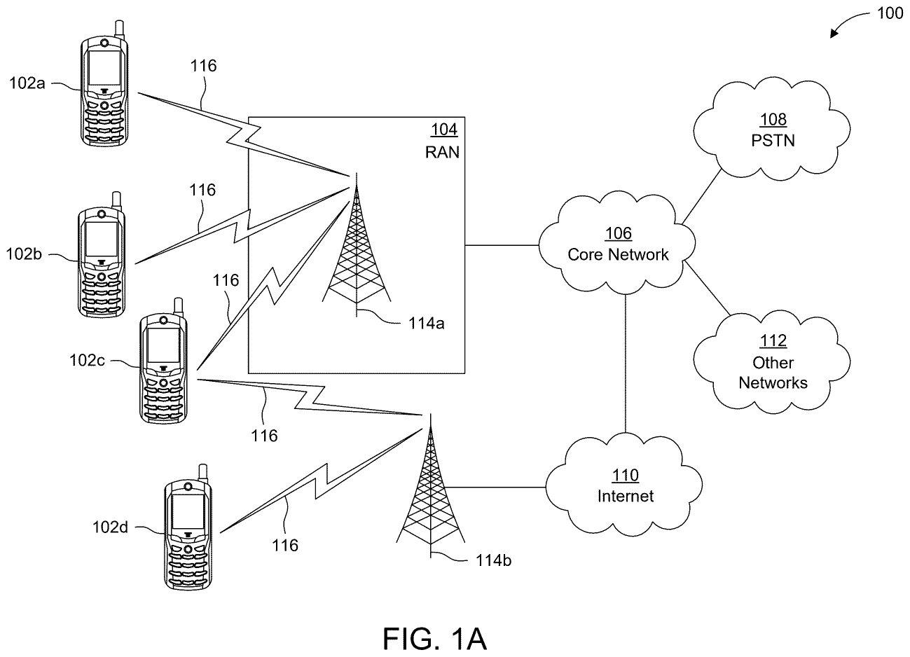

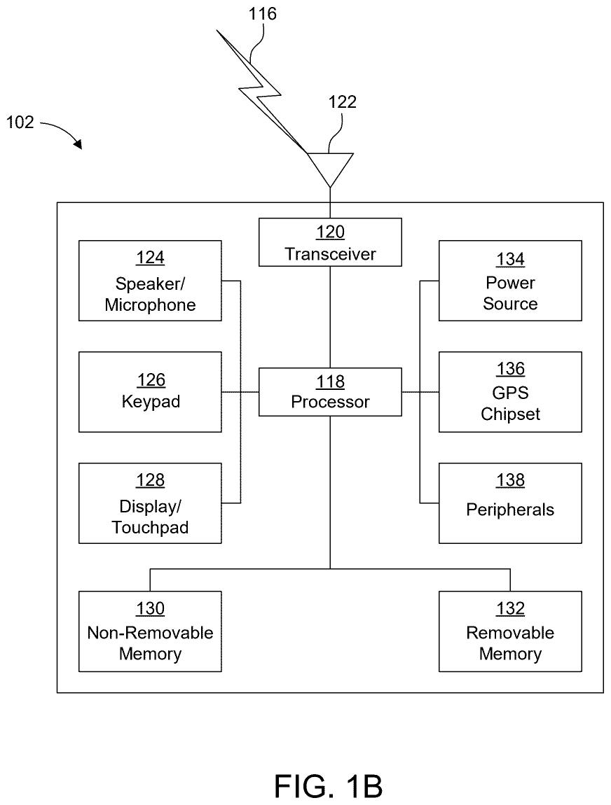

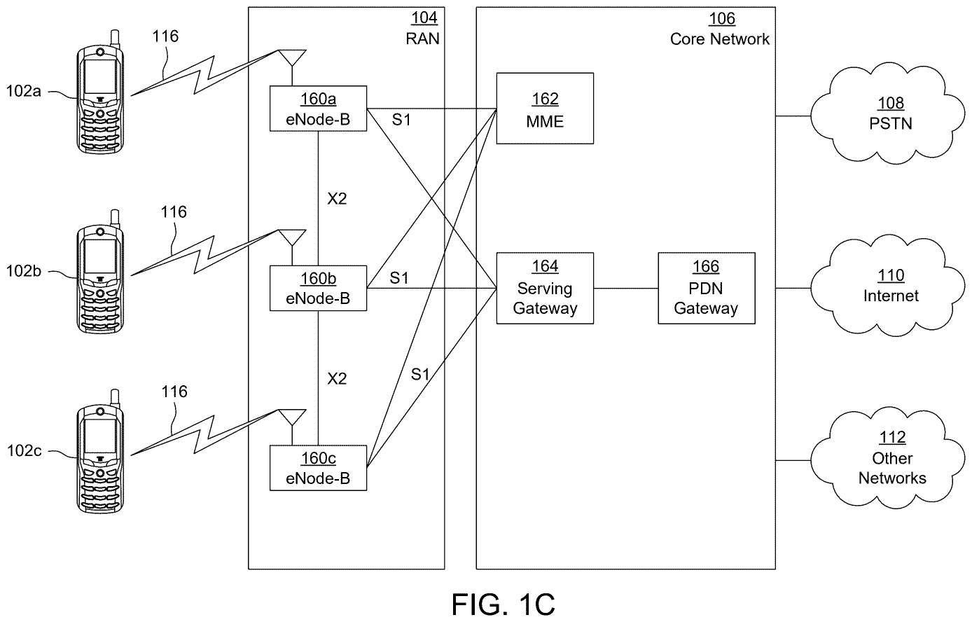

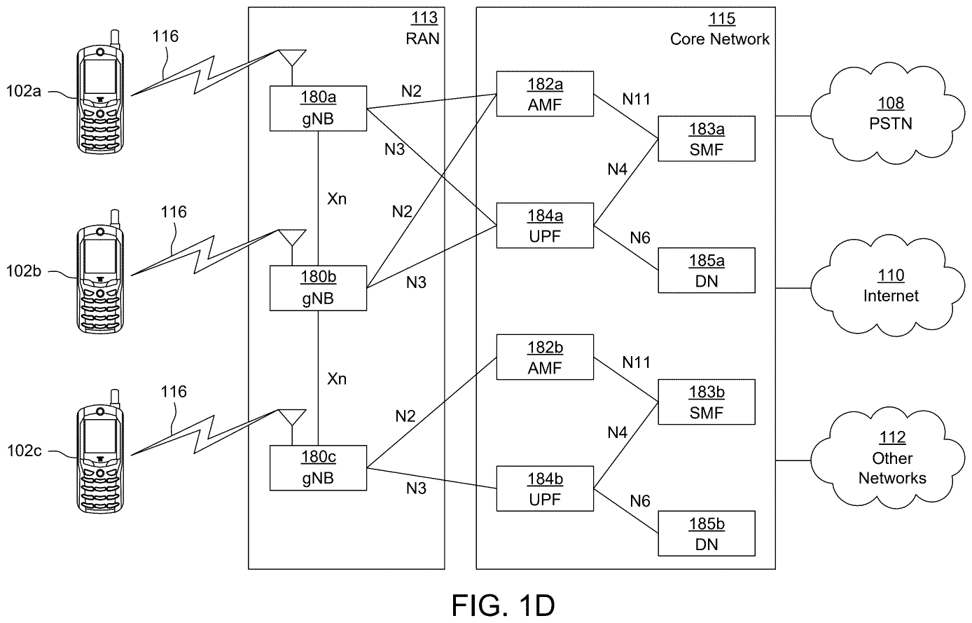

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (CNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), an universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

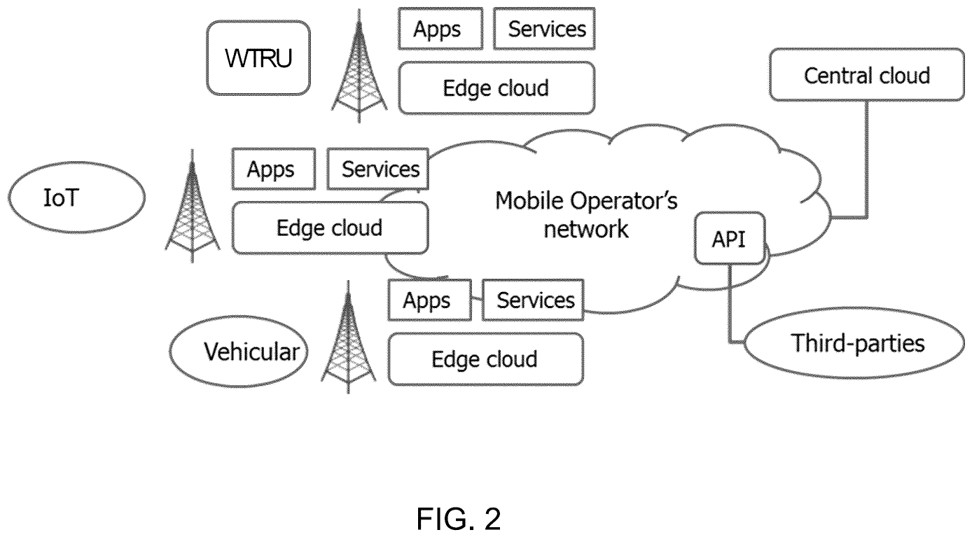

European Telecommunications Standards Institute (ETSI) Industry Specification Group (ISG) Multi-access Edge Computing (MEC)—formerly known as Mobile Edge Computing—describes how computing capabilities deployed in the edge of the mobile network may facilitate the efficient and dynamic provisioning of services to mobile users and applications. Referring to FIG. 2, ISG MEC specifies an open environment for integrating MEC capabilities with communication service providers' networks, including applications from 3rd parties. These distributed computing capabilities may make available information technology (IT) infrastructure, as in cloud environments, deployed in or near mobile access networks, including 5G, WLAN, etc.

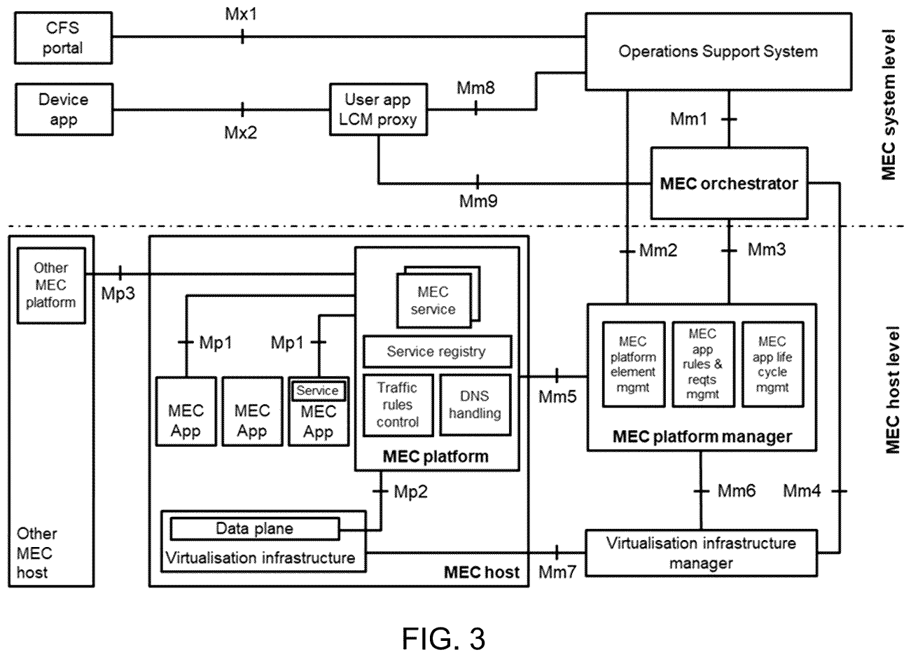

Referring to FIG. 3, an ETSI MEC reference architecture with the functional elements that may comprise a mobile edge system and the reference points between them, is shown.

Three groups of reference points may be defined between the MEC system entities: (i) reference points regarding the mobile edge platform functionality (Mp), (ii) edge management reference points (Mm), (iii) reference points connecting to external entities (Mx) from the MEC system.

A mobile edge system may consist of the multi access edge hosts and the multi access edge management functions necessary to run mobile edge applications at the network edge.

A multi access edge host may be an entity that contains a multi access edge platform and a virtualization infrastructure which provides compute, storage, and network resources, for the purpose of running multi access edge applications.

A multi access edge platform (MEP) may be a collection of essential functionalities required to run mobile edge applications on a particular virtualization infrastructure and enable them to provide and consume mobile edge services.

A multi access edge applications (MEC App) may be instantiated on a virtualization infrastructure of a mobile edge host based on configuration requests validated by the mobile edge management.

A multi access edge service (MEC Service) may be a service provided and consumed either by the MEC platform, MEC management functions, or by MEC applications. When provided by a MEC application, a MEC service can be registered in the list of services with the MEC platform over a Mp1 reference point.

A certain number of MEC services may be necessary, such as RNIS (Radio Network Information Service), location service, bandwidth management service, traffic management service, and others.

A mobile edge management may comprise mobile edge system level management functions and mobile edge host level management functions.

The mobile edge system level management may include a multi access edge orchestrator (MEO) as its core component, which may have a visibility and control over the complete mobile edge system.

The mobile edge host level management may comprise a multi access edge platform manager (MEPM) and a virtualization infrastructure manager (VIM) which may handle the management of the mobile edge specific functionality of a particular mobile edge host and the MEC applications running on it.

Document “ETSI GS MEC 010-2, MEC Management; Part 2: Application lifecycle, rules and requirements management” may define edge application lifecycle management and resource allocation procedures for MEC systems. MEC 010-2 procedures may include application onboarding, application instantiation (including reserving edge resources on a MEC host for an application), application termination, and operational state changes (start & stop).

The ETSI MEC specifications may not support a method to modify the edge resources allocated to a running MEC application. To modify edge resources allocated for a running MEC application instance, a new MEC application package must be onboard to the MEC system (with the new or modified resource parameters), the running MEC application instance terminated, and the new application instance created with the modified edge resources allocated per its requirements. This method of onboarding a new application instance package, instantiating a new instance per that package, and then terminating the currently running instance to change resources may be slow and cannot meet the needs of dynamic 6G applications such as immersive Extended Reality (XR) experiences, collaborative autonomous vehicles/drones, human interactive robotics, etc.

There is an ongoing study in ETSI ISG MEC titled “MEC in resource constrained terminals, fixed or mobile” (DGR/MEC-0036ConstrainedDevice) which may aim at studying how terminal units, mobile hosts and personal devices can be used to support edge computing in mobile and wireless connected devices. The study focuses on these aspects: (i) Limited availability of compute resources for running MEC applications and its impact on life cycle management of VMs, containers or other form of virtual instances; (ii) mobility of constrained terminals impacting reachability of MEC applications, maintenance of reasonable connectivity, device availability and discovery of appropriate services; (iii) impact of unavailability of reliable high bandwidth backhaul connectivity (e.g., wired or wireless); and (iv) security and authorization to use a constrained terminal, privacy of user data.

There are different scenarios where it may be advantageous to enable a reduced capability MEC platform (Constrained MEC (CMEC)) for deployment on constrained devices, thus allowing MEC apps to be instantiated on these constrained devices, including but not limited to the following: (i) vehicular scenarios, where a Constrained MEC Host (CMH), embedded in a vehicle, might run applications for the vehicle (like onboard processing of sensed data), other neighboring vehicles (e.g., in platooning situations) or for the edge network (for safety and traffic efficiency applications); (ii) industry 4.0 scenarios, where mobile robots or robot arms, mobile cameras can also host MEC applications to minimize the latency required by certain use cases; (iii) XR gaming scenarios, where cloud-based gaming applications using AR/VR might need ultra-low latencies and/or extended computational capabilities, which can be provided by CMHs in the same household.

This study has captured a solution where MEC app edge resources may be reallocated to a MEC app at run-time via an enabler service for XR applications.

However, the study has identified an open issue regarding how that XR enabler service (e.g., which may be offered from a MEC app) may coordinate with the MEC system to determine resource availability, requests & assigns new edge resource reallocations, and inform the impacted MEC apps of new resource allocations.

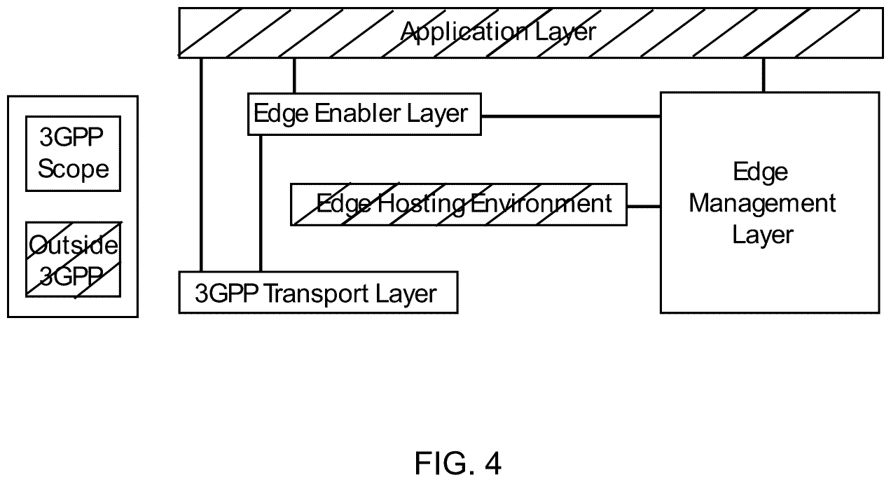

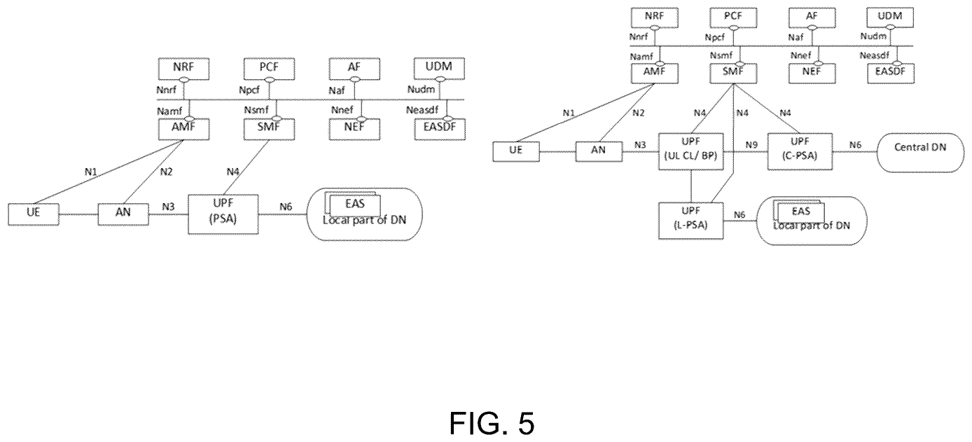

5G system architecture consists of User Equipment (UE) (e.g., wireless transmit/receive unit (WTRU)), Radio Access Network, and Core Network. 3GPP may support integration and deployment of edge computing within 5G systems as show in FIG. 4 and FIG. 5. Edge Application Servers (EAS) may offer edge services to devices (UEs) and are deployed within edge data networks accessed via the 5GS. 3GPP TS 23.501 and 3GPP TS 23.548 may define edge support within a 3GPP Transport Layer, including edge traffic routing and configuration. 3GPP TS 23.558 may define the Edge Enabler layer in a “5G architecture for enabling edge applications” (also referred to as Edge Application Enablement or EDGEAPP). 3GPP TS 28.538 may define the Edge Management Layer, which includes edge application lifecycle management, performance assurance, and fault management. Deployment of edge applications on mobile devices (e.g., WTRU) may be not supported in 5G specifications.

An objective of a 5G Edge Enablement Layer may be to facilitate communication between Application Clients (ACs) running on WTRUs and Edge Application Servers (EASs) deployed within Edge Data Networks. It may provide interfaces and Application Programming Interfaces (APIs) for application developers (WTRU and EAS) to leverage 5GS edge capabilities, including edge service provisioning, EAS discovery/selection by ACs, and edge service continuity (e.g., due to WTRU mobility). Via Edge Enablement Layer (EDGAPP), ACs may be able to find, connect, and switch (when needed) to the most appropriate EAS instance in an edge data network to meet the requirements and performance needed for an application.

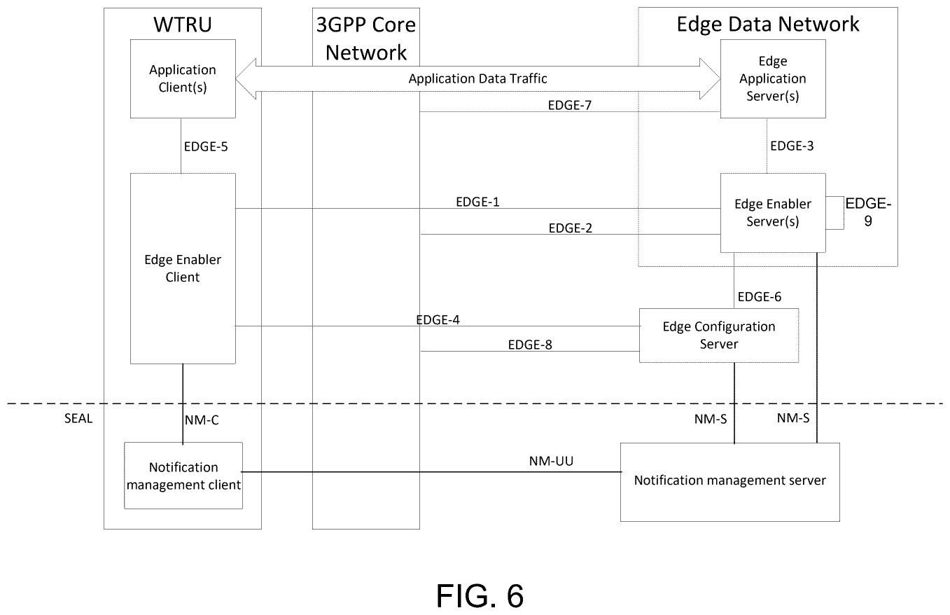

Referring to FIG. 6, the EDGEAPP architecture may comprise of Edge Enabler Server (EES), primarily responsible for enabling discovery of the EASs; Edge Enabler Client (EEC), providing support functions, such as EAS discovery to the ACs in the WTRU; and, Edge Configuration Server (ECS), providing edge configurations to the EEC, in order to connect with an EAS.

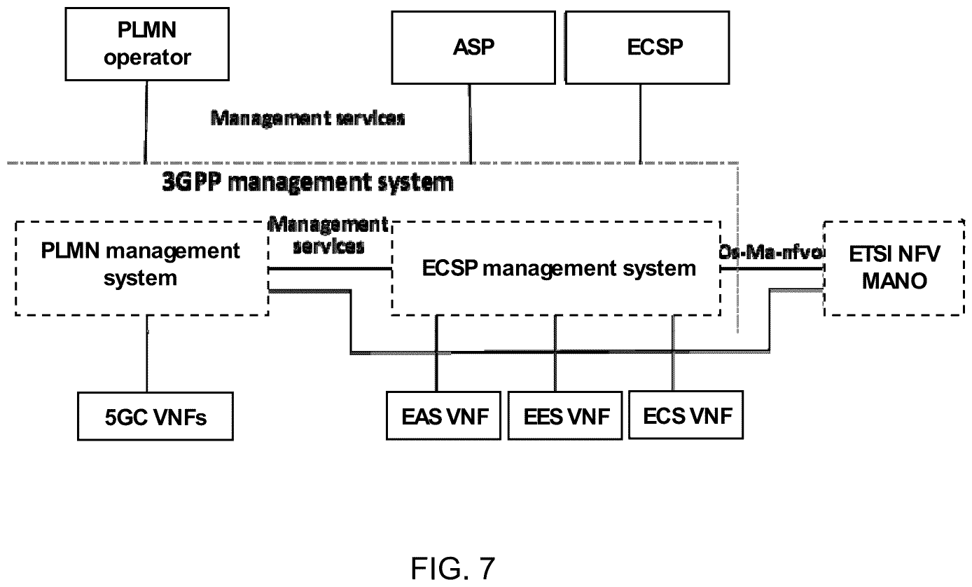

A Edge Computing Management (ECM) Framework may responsible for an onboarding, deployment/instantiation, and overall lifecycle management of edge applications (EASs) within a 5GS. ECM may consider the roles of different stakeholders including mobile network operators (Mobile Network Operator (MNO), Public Land Mobile Network (PLMN) operators), edge computing service providers (ECSPs), and edge application providers (ASPs) or developers. The capabilities provided by a 5G ECM may include EAS lifecycle management, edge app performance edge app assurance, fault supervision, and coordination with 5GC Network Function (NF) provisioning. An ECM architecture is depicted in FIG. 7.

Referring to FIG. 7, a ECSP management system may manage EASs and elements of the EDGEAPP service layer (EES, ECS) as virtualized network functions (VNFs), while coordinating management services of the MNO NF/VNFs in the 5GS. ECM capabilities for edge application management operations may include EAS deployment, EAS termination, EAS modification, and EAS relocation. ECM framework may define two operational options: 1) ETSI NFV-based or 2) ETSI MEC-based. In the ETSI NFV-based option, the ECSP management system may interface with the NFV orchestrator (NFV MANO) for EAS, EES, and ECS lifecycle management. In the ETSI MEC-based option, the ECSP management system may interface with the MEC Orchestrator (MEO) for EAS, EES, and ECS lifecycle management via the interfaces and services defined in ETSI MEC GS 10-2.

In the ETSI NFV option, ECM may support EAS modification to adjust VNF information for one or more EASs instances deployed within a network service, updating configurable VNF instance properties. However, this capability may be only available to the ASP backend and may not be accessed and utilized by an EAS instance or AC to modify its edge resource allocations on an edge host.

In the ETSI MEC option, ECM support for EAS modification may one modify the operational state of an EAS: Start/Stop. The EAS modification procedure may not modify any edge resource allocations for an EAS. To modify edge resources, a new EAS instance may need to be onboarded, deployed, and instantiated to replace the current EAS, which is terminated.

As an alternative to the standardized ETSI MEC and 3GPP ECM options, proprietary or open virtualization environments may be utilized to manage edge applications (lifecycle management, etc.) and assign/modify edge resources assigned to them in virtualization formats such as virtual machines, containers, etc. These virtualization environments may commonly support application vertical scaling (e.g., including at run-time resource allocation adjustments) to modify the resources assigned to edge applications.

However, application vertical scaling may be controlled in virtualization environments' management plane via “centralized” controller nodes or control portals that are used by overall system or application vertical administrators. These centralized solutions may not react in a timely fashion in a 6G distributed edge environment (with mobile and constrained edge nodes) or for the dynamic 6G applications that need to quickly adapt to changing network and computing conditions. Additionally, these methods may require administrative privileges that are not available for direct use by an edge application or application client due to security and access control restrictions.

Many 6G applications (e.g., immersive XR experiences, collaborative autonomous vehicles/drones, human interactive robotics, etc.) may face challenges in adapting their run-time operational behavior in presence of dynamically changing conditions in network and computing resources (including network bandwidth, network latency, packet loss, response times, CPU levels, storage, GPU levels, etc.). Although prospective 6G/Next G systems and networks may offer new opportunities in terms of resource availability, these may pose additional challenges since computing resources in 6G/Next G systems and networks may be highly distributed throughout the entire network, including on mobile and constrained edge hosts. For example, computing resources may be deployed in centralized cloud data centers, regional/metro/core network edge locations, radio access network sites (e.g., edge hosts co-located with a gNB, WiFi AP), customer premise networks & on-premises gateways/routers/access points, personal IoT networks, and mobile edge devices (i.e., cars, drones, robots, smartphones, etc.).

For example, within a multi-player immersive XR game, the video rendering function, which may create XR video for a player, may be offloaded from the player's XR glasses to a nearby 6G distributed edge node (e.g., Customer Premise Network (CPN) gateway or on-premises edge node, connected car edge host, or a user edge device such as a smartphone) to reduce size, cost, heat, etc. in the XR glasses and to improve XR user experience performance for the player. As the immersive XR game may progress and the player may move, various conditions may change: 1) within the game (level of rendered objects increases or decreases); 2) in the network (bandwidth, latency, packet loss, etc.); 3) on the edge computing devices (CPU, storage, GPU, inference, availability, etc.); etc. The combination of all of these factors may cause the XR rendering function to adapt its operation at run-time (e.g., render more or less objects; increase or decrease video resolution, frame rate, etc.; increase or decrease video compression, etc.), which may impact its need for allocated edge resources.

In 5G systems, edge compute resources may be commonly deployed in core network data centers. These core network data centers may be not resource constrained in comparison to the 6G distributed edge (within RAN, CPN, Personal IoT Network (PIN), mobile edge devices, etc.). Resource scaling techniques used in cloud computing, such as over-provisioning and centralized controller modification methods, may be used to adjust edge resources in 5G systems. These methods may break down and may be impractical for 6G/Next G systems with highly distributed edge computation locations, including resource constrained mobile device edge nodes with limited capabilities and applications that may require dynamic/run-time edge resource adjustment. In other words, these methods may break down and may be impractical when edge computation resources are deployed on mobile devices (the mobile devices may be edge nodes).

As such, methods may be needed to, in response to changing conditions, dynamically adjust the edge resources allocated to a running edge application or group of edge applications to maintain the needed application-level or user performance (e.g., sufficient XR user experience quality) while not negatively impacting the edge applications availability, while efficiently utilizing limited resources on 6G distributed and constrained edge devices (including UEs).

The following key issues may have to be addressed: (i) How can the edge resources (e.g., CPU, GPU, memory, storage, FPGA, AIML, etc.) assigned to an edge application or group of edge applications be re-allocated at run-time, when initiated by the edge application or an application client, in order to maintain needed application vertical performance, availability, and user-experience? (ii) How can an edge application (or application client) determine the level of edge resources within an edge network or system that may be available for reallocation at run-time?

The following terms are used in the below various embodiments.

Application Client (AC): AC may utilize edge applications within an edge system. ACs may typically run on mobile devices or WTRUs (e.g., user equipments). ACs may also be cloud applications or other edge applications. AC may be an equivalent to a Client Application as defined in ETSI MEC or an Application Client as defined in 3GPP.

AC Edge Enablement Function (AEEF): AEEF may be an edge enablement function for Application Clients to utilize edge services and capabilities. AEEF may provide services to an AC to coordinate and authorize interactions with an edge system. AEEF may be equivalent to a Device App as defined in ETSI MEC (that may interact with the UALCMP) or an Edge Enabler Client (that interacts with the EES) as defined in 3GPP.

Device: a device may connect to an access network for connectivity to one or more data networks (including edge data networks) or to other devices (via D2D or access network). Devices may be equivalent to a User Equipment (UE) as defined in 3GPP (e.g., a WTRU).

Device Edge Host: A device edge host may be an edge host that is realized on a device. A Device Edge Host may be mobile or stationary. Device Edge Hosts may be deployed on constrained devices, in terms of limited edge resources, compared to edge hosts in regional/metro/core network edge data networks or data centers.

Edge Application (EA): an EA may be an edge application that is deployed on an edge host (including device edge host) within an edge system and may provide services to ACs or other EAs. EA may be equivalent to a MEC App as defined in ETSI MEC or an Edge Application Server (EAS) as defined in 3GPP.

Edge Application Descriptor (EAD): an EAD may include information needed for an Edge System to deploy and manage an EA. Information included in an EAD may include EA name, EA ID, EA description, EA version, Edge Resource Descriptor (ERD), EA traffic rules or policy, EA DNS rules or policy, SW image or EA installation package/link, etc.

Edge Application Vertical: an Edge Application Vertical may be a collection of EAs and optionally ACs that interact to provide user or application-level functionality. Examples of edge application verticals may include, but are not limited to: XR games or experiences, autonomous vehicles or drones, smart or automated manufacturing, human collaborative robotics, etc.

Edge Application Enablement Function (EAEF): EAEF may offer services that enable an edge application to operate on an edge host (including device edge host). Enablement services may include EA registration, UE location, edge traffic steering configuration, etc. EAEF may be equivalent to a MEC Platform (MEP) as defined in ETSI MEC or an Edge Enabler Server (EES) as defined in 3GPP.

Edge Host: Edge Host may be an entity that contains or utilizes an EAEF, Edge Host Management Function (EHMF), and Virtualized Infrastructure (VI) in order to deploy and manage edge applications within an edge system. An Edge Host can also be referred to as an edge node. EAEF and EHMF may be realized directly on an Edge Host node or may be realized on another node in the system. For example, due to resource constraints on a constrained edge host, the EAEF and EHMF may be deployed on a near-by and more capable platform. An Edge Host may be equivalent to a MEC Host (MEH) as defined in ETSI MEC.

Edge Host Management Function (EHMF): an EHMF may manage the virtualized or edge resources for one or more edge hosts. For example, an EHMF may allocate or assign edge resources to EA on an edge host.

Edge System: An Edge System may be a collection of Edge Hosts (including device edge hosts) and management functions to deploy and run EAs and offer edge services or capabilities to ACs.

Edge System Management Function (ESMF): an ESMF may provide edge system-wide management of edge applications, edge hosts, and virtualized edge resources in an edge system. Commonly referred to as edge orchestration or orchestrator. An ESMF may be equivalent to as the MEC Orchestrator (MEO) and OSS/BSS as defined in ETSI MEC, or an Edge Computing Management (ECM) system as defined in 3GPP.

Virtualized or Edge Resources: Virtualized or Edge Resources may include compute, storage, memory, GPU, AI/ML, etc. edge resources provided by a VI.

Virtualized Infrastructure (VI): Virtualized Infrastructure may be hardware and/or software components that provide virtualized resources to run EAs. Typically, the VI may be controlled or managed by an EHMF.

Edge Resource Modification Descriptor (ERMD): An ERMD may be information that describes edge resource modifications. An ERMD may include an EAVPI or an ERD list. An EAVPI may be interpreted by an AEEF, EAEF, or EHMF to request specific edge resource modifications. An ERD list entry may include a EAPI or a complete set of edge resource parameters or may include only the parameters impacted by a modification. All omitted parameters are then retained with previous settings.

Edge Resource Query Descriptor (ERQD): An ERQD may be information that describes edge resources to be queried for availability. An ERQD may include an EAVPI or an ERD list. An EAVPI may be interpreted by an AEEF, EAEF or EHMF to determine specific edge resources to query for an EA or edge application vertical (i.e., a collection of EAs). An ERD list entry may include a EAPI or a complete set of edge resource parameters or may include only the parameters requested for query. If all parameters are omitted, then all parameters are queried. Additionally, each resource query may contain a type (e.g., CPU) and a value/range (e.g., 50-75, which indicates the CPU resource level of interest for the query).

Edge Application Performance Index (EAPI): An EAPI may be a qualitative metric that specifies the performance (e.g. response rate, response time or latency, number of connections, edge resource utilization, data accuracy or quality, bandwidth, user experience quality, or other application-vertical specific performance metrics) of an EA instance. A given EAPI may determine the specific edge resources that need to be allocated to an EA instance.

Edge Application Vertical Performance Index (EAVPI): An EAVPI may be a qualitative metric that specifies the overall performance (e.g. response rate, response time or latency, number of connections, edge resource utilization, data accuracy or quality, bandwidth, user experience quality, or other application-vertical specific performance metrics) of an edge application vertical (e.g., a collection of EAs). A given EAVPI may determine the specific edge resources that need to be allocated for each EA instance within the application vertical to meet the specified application vertical performance level.

Edge Resource Descriptor (ERD) List: An ERD list may include edge resource requirements per EA. Each ERD entry in the list may include an EA identifier (e.g., identifier of the EA), an EAPI, and/or a description of the EAs required edge resources, such as CPU resources, memory resources, storage resources, service dependencies, feature dependencies, latency requirements, response time/rate limits, GPU resources and limits, FPGA resources and limits, interface descriptors, platform or virtualization accelerator requirements, etc. An EAPI in an ERD entity may be interpreted to determine the EA's required edge resource requirements to achieve a performance level.

The various below embodiments may propose solutions to dynamically (e.g., at run-time) modify or adjust edge resources allocated to an edge application or group of edge applications to jointly optimize user-performance or application-level performance of an edge application vertical while optimizing the edge resources on edge hosts within an edge system. Joint optimization of edge application vertical performance with edge resource allocations may be especially important in future NextG/6G edge systems, where edge applications may be deployed on mobile device edge hosts with constrained edge resources in comparison to 5G edge data centers and nodes.

The benefits of the below various embodiments include: 1) adaptation of edge applications at run-time, based on changing conditions (including networking, computing & storage, application-level behavior/conditions, and other resources), to satisfy the high-performance requirements of NextG/6G applications; 2) optimal allocation of edge resources (including on device edge hosts) while not over-provisioning resources to save on costs, reduce device size, save power consumption, etc., while maintaining expected user-experience or application-level performance.

The various below embodiments may be based on the following design principles: 1) flexible and diverse edge system architectures and deployments, including 5G telco edge in fixed-location edge data networks and 6G device edge with mobile edge hosts (for example, deployed in vehicles, on drones, or consumer mobile devices); 2) compatibility with standardized edge computing frameworks such as 3GPP and ETSI MEC with applicability to non-standardized proprietary frameworks from cloud or edge computing service providers; 3) applicable to multiple types of access networks including 5G, 6G, Next G, WiFi, Fixed Access, PIN, CPN, etc.

The below various embodiments may be applied within 5G edge systems, that included telco edge hosts in edge data networks, and to future Next G/6G systems that may include mobile device edge hosts.

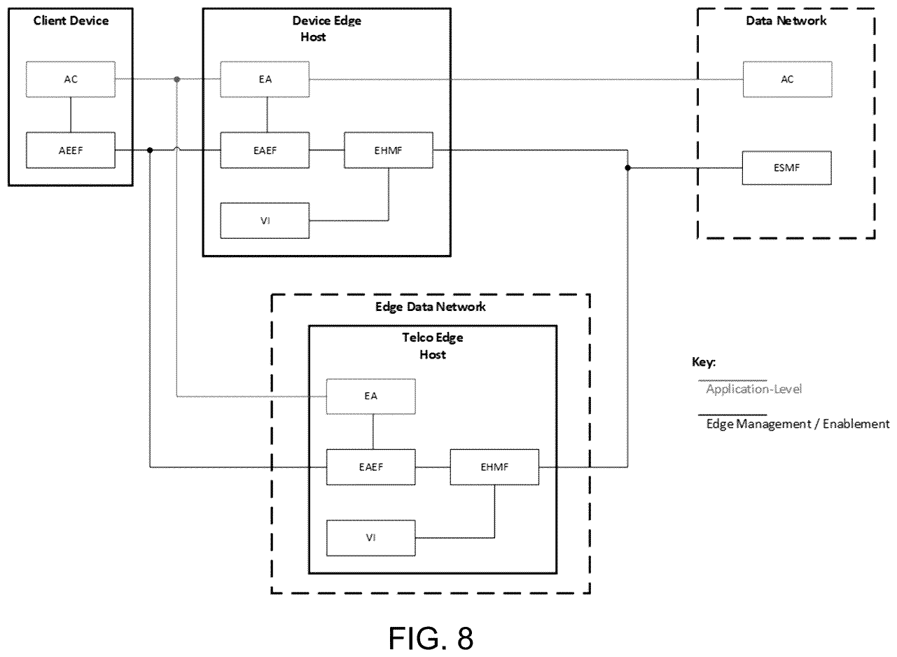

FIG. 8 depicts an example of Next G/6G functional system architecture that realizes the solutions in this paper. The functional system architecture may include: 1) Client Device (WTRU) that may utilize edge services (including from EAs) on device edge and/or telco edge hosts; 2) Device Edge Host that may offer edge services to ACs that may be mobile or stationary (examples of Device Edge Hosts include: vehicles, gateways within a CPN/PIN/other network, mobile-user device); 3) Telco Edge Host within an edge data network (fixed location) that may offer edge services to ACs; 4) Data Network that may include edge system-level management functionality, ACs that use EAs on device edge or telco edge hosts, etc.

The functions in FIG. 8 may be deployed within a Next G/6G System Architecture as described in the following table. Note, a Device Edge Host may be realized on a mobile or stationary terminal device (WTRU). A Telco Edge Host may be realized within an Edge Data Network (in an edge data center or node) and is typically stationary.

| Function: | Deployment Options: |
|---|---|
| Application | An AC may be a client application deployed on a |
| Client | terminal device (e.g., a WTRU) |
| (AC) | Alternatively, a client application can be deployed |
| | in the cloud (data network) or in another edge host |
| | (device or telco edge) |
| AC Edge | An AEEF may be an enabler service for ACs deployed |
| Enablement | on a mobile or stationary terminal device (e.g., |
| Function | a WTRU) Alternatively, enabler service can be |
| (AEEF): | deployed in the cloud (data network) or in an edge |
| | host (device or telco edge) - not shown in FIG. 8 |
| | for simplicity. |
| Edge | An EA can be deployed on a Device Edge Host and |
| Application | provides services to ACs |
| (EA) | An EA can be deployed on a Telco Edge Host and can |
| | provide services to ACs |
| Edge | An EAEF may be an enabler service that can be |
| Application | deployed on a Device Edge Host (e.g., a WTRU) and |
| Enablement | providing services to EAs |
| Function | An EAEF is an enabler service that can be deployed on |
| (EAEF) | a Telco Edge Host and providing services to EAs |
| Edge Host | An EHMF may be a Host management system that can |
| Management | be deployed on a Device Edge Host (e.g., a WTRU) |
| Function | An EHMF may be a Host management system that |
| (EHMF) | can be deployed on a Telco Edge Host |
| | Alternatively, a EHMF instance may manage several |
| | edge hosts. In such cases, the EHMF may be deployed |
| | on another edge host (device edge host or a telco edge |
| | host) or as a centralized function in a data network |
| | in a core network data center or in the cloud. |
| Virtualized | VI may be virtualized edge resources that can be |
| Infrastructure | deployed on a Device Edge Host (e.g., a WTRU) |
| (VI) | VI may be virtualized edge resources that can be |
| | deployed on a Telco Edge Host |
| Edge System | ESMF may be a system-wide edge management system |
| Management | that can be deployed in a data network in a core |
| Function | network data center or in the cloud. |
| (ESMF) | |

Device Edge Hosts may be realized on different types of terminal devices with varying levels of edge resources and function capabilities. Capable device edge hosts, such as those deployed within a on-premises gateway (enterprise or consumer) or within an automobile, may support the system architecture described in FIG. 8 with a full set of functions on a device edge host. However, other Next G/6G device edge host form-factors may be constrained in edge resources and may not be able to locally run the set of functions shown in FIG. 8. These constrained device edge hosts may be realized within form factors such as drones, mobile robots, edge appliance nodes within a CPN or 5G/6G LAN, personal edge devices, etc.

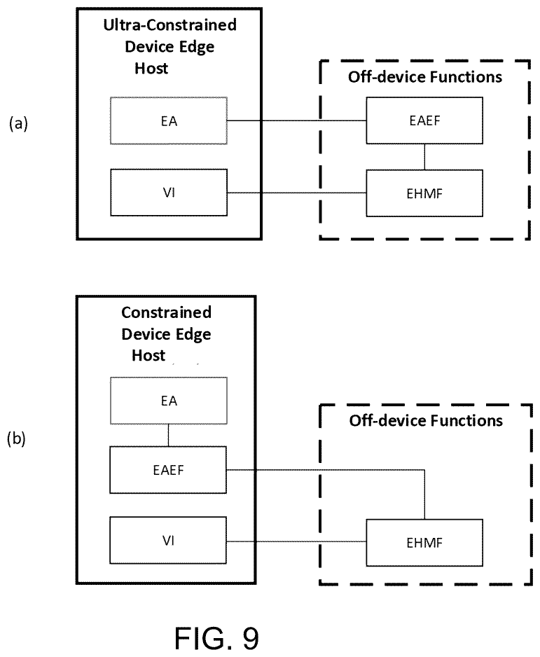

Alternative functional architecture options that consider constrained device edge hosts are shown in FIG. 9.

Referring to FIG. 9, option (a) depicts an ultra-constrained device edge host with the most limited edge resources and functions. In this option, EA(s) and the VI may be realized on the ultra-constrained device edge host, while the EAEF and EHMF may be realized off-device. An example ultra-constrained device edge host could be a 6G wearable device (such as a pair of mixed reality glasses).

Referring to FIG. 9, option (b) depicts a constrained device edge host with more edge resources compared to option (a). In this option, EA(s), the EAEF, and VI may be realized on the constrained device edge host, while the EHMF is realized off-device. An example constrained device edge host could be a 6G wireless edge appliance in a CPN that interconnects with a on-premises gateway that hosts the EHMF for all edge hosts in the CPN.

In both options, the off-device functions may be realized: 1) on another Device Edge Host; 2) on a Telco Edge Host; 3) as an AF, NF, or service enabler in a data network. The connection between an ultra-constrained or constrained device edge host and the off-device functions may be via a D2D, 5G, 6G, WiFi, Fixed Access, etc.

The various embodiments below may be realized within a 3GPP mobile network and may be integrated with edge computing functionality.

The following functions may be integrated with or realized in the following entities in the 3GPP edge computing architecture: AC may be integrated with or realized as an Application Client; AC Edge Enablement Function may be integrated with or realized in an Edge Enabler Client; Edge Application may be integrated with or realized as an Edge Application Server; Edge Application Enablement Function may be integrated with or realized in an Edge Enabler Server; Edge Host Management Function may be integrated with or realized in an ECSP Management System; and Edge System Management Function may be integrated with or realized in an ECSP Management System.

The various embodiments below may be realized within a ETSI MEC system and its reference.

The following functions may be realized integrated with or realized in the following functional elements in the ETSI MEC reference architecture: AC may be integrated with or realized in a Client Application; AC Edge Enablement Function may be integrated with or realized in a Device Application; Edge Application may be integrated with or realized as MEC Application; Edge Application Enablement Function may be integrated with or realized in a MEC Platform; Edge Host Management Function may be integrated with or realized in MEC Platform Manager and Virtualization Infrastructure Manager; VI may be integrated with or realized as the Virtualization Infrastructure; Edge System Management Function may be integrated with or realized in MEC Orchestrator; and EA descriptor may be integrated with or realized in a MEC Application Descriptor.

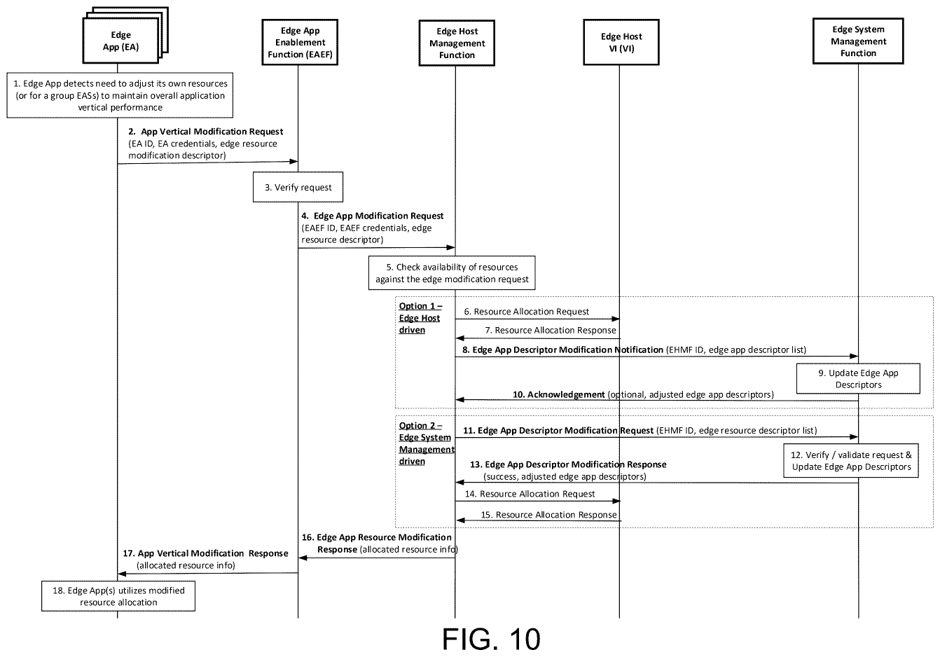

In an embodiment, an Edge Application (EA) may initiate modifications, at run-time, of edge resources (e.g., CPU, memory, disk, storage, GPU, HW/FPGA, AIML, and other resources) allocated for one or more Edge Applications to maintain overall edge application vertical performance. Referring to FIG. 10, an EA may detect the need for an adjustment of edge resources to maintain application performance and requests edge resource modification with an Edge System via an Edge Application Enabler Function (EAEF) described herein. The EAEF may interface with an Edge Host Management Function (EHMF) described herein and the Edge System Management Function (ESMF) described herein to determine available edge resources and to modify the edge resource allocations to the EA(s), as needed, based on a modification request. This procedure, as shown in FIG. 10, may include two options: option 1) edge resources may be locally modified by the EHMF and then informed to the ESMF at a system level; or option 2) the local EHMF may verify edge resource re-allocation with the ESMF before performing edge resource modification on the edge host.

An edge application vertical may be deployed within an Edge System and is composed of several EA instances that may be instantiated on one or more edge hosts, including device edge hosts. These EA instances may be of the same or different edge application types. At least one EA instance may have sufficient security credentials and trust to request edge resource modifications with the edge system.

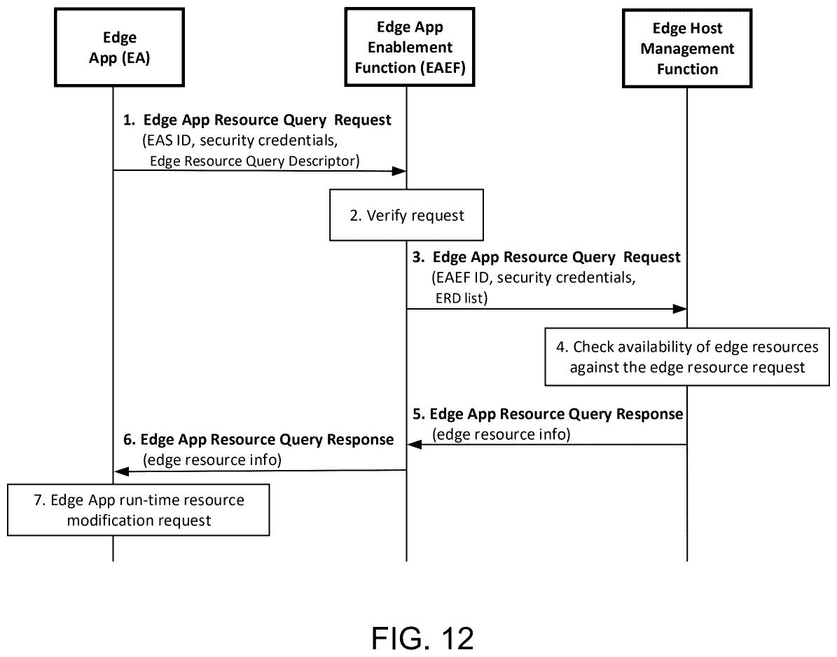

Referring to FIG. 10, at step 1, an EA may detect a need to adjust edge resources for itself and/or other EA(s) within an edge application vertical. The EA may utilize services of a AIML enabler client or service to derive performance statistics or predications to characterize or determine edge resource requirements for the edge application vertical's specific context (e.g., time of day, location of ACs & EAs, mobility profile, network load, etc.). For example, an XR rendering EA may determine the need to render more or less objects, to increase or decrease video resolution, to change video frame rates, to increase or decrease video compression, need to reduce power consumption to maintain battery level, etc., including combinations of all. Based on edge application vertical needs and available edge resources (e.g., determined by the solution described in FIG. 12), the EA may determine the required edge resource modifications for one or more EA(s) in the edge application vertical to maintain expected overall edge application vertical performance.

Referring to FIG. 10, at step 2, the EA may send an Application Vertical Modification request to an EAEF to update the edge resources for the EAs determined in Step 1. The Application Vertical Modification may include an EA identifier, EA security and trust credentials, and an ERMD described herein. The ERMD may include the edge resource modifications for each impacted EAs determined in Step 1.

As a first example, if an EA needs to adjust its own edge resources as determined in Step 1, the EA may transmit an ERMD that includes a single ERD which may include a desired EAPI, or a description of the EA's adjusted edge resources determined based on pre-configuration, policy, or internal EA considerations.

As a second example, if an EA needs to adjust the edge resources for a group of EAs (e.g., for an edge application vertical) as determined in Step 1, the EA may transmit an ERMD that may include an overall EAVPI for the group or an ERD list which includes an EAPI for each EA or a description of each EA's adjusted edge resources. This determination may be based on pre-configuration, policy, internal EA considerations, or edge application-vertical level configuration.

Referring to FIG. 10, at step 3, the EAEF may verify the Application Vertical Modification request received from Step 2. The EAEF may verify the EA ID and security credentials to ensure that the request is valid, and that the EA has sufficient permissions for itself and for the EA(s) included in the ERMD. The EAEF may verify the trust index or level of the requesting EA (and included EAs in the ERMD), either directly or via a trust management service. If the Application Vertical Modification request is determined to be invalid (including not trusted), the EAEF may reject the request, and the procedure may continue in step 17 of FIG. 10.

Referring to FIG. 10, at step 4, the EAEF may check the availability of edge resources with the EHMF via an Edge Application Modification request, described herein. If the Application Vertical Modification request received from the EA includes an ERMD with an EAVPI, the EAEF may interpret the EAVPI and translate it into an ERD list. In other words, the ERD list may be a list of the types of resources that are required and the EA VPI maybe understood as representing the resources in the ERD list that are required to meet an edge application vertical performance level.

The EAEF may transmit an Edge Application Modification request to the EHMF. The request may include an EAEF identifier (e.g., an identifier of the requesting EAEF), EAEF security and trust credentials, ERMD including an ERD list or EAVPI, and any information from the Edge Application Modification request received from the EA. For example, the request may include the ERD list obtained in the Edge Application Modification request received from the EA, or an ERD list generated from the EAVPI received in the Edge Application Modification request. The ERD list may include the edge resource modifications required for each requested EA. An ERD entry in the list may include an EAPI or an adjusted edge resource descriptions as a complete parameter set or only the parameters impacted by modification. All omitted parameters may be retained. In this context, the word retained means that the requirements of an existing configuration may be assumed. In another example, the EAEF may forward the received EAVPI to the EHMF in place of the ERD list.

If the ERD list includes EAs that are deployed across on several distributed edge hosts that a managed by separate EHMFs, the EAEF may transmit an Edge Application Modification request to each EHMF for their respective EAs in the ERD list. The EAEF may create a filtered ERD list with entries relevant for each EHMF or it may send the full ERD list.

Referring to FIG. 10, at step 5, the EHMF may verify the Edge Application Modification request from the EAEF, including checking the EAEF ID, EAEF credentials, and ERMD or ERD list. The EHMF may verify the trust index or level of the requesting EAEF, cither directly or via a trust management service. If the Edge Application Modification request is determined to be invalid (including not trusted), the EHMF may reject the request, may transmit an error indication to the EAEF from Step 4 of FIG. 10, and the procedure continues in step 16 of FIG. 10.

If the request from the EAEF in Step 4 of FIG. 10 included an EAVPI, the EHMF may generate an ERD list based on the received EAVPI. If the received or generated ERD list includes EAPIs, the EHMF may process each EPVI to determine the specific edge resources that need to be modified for each EA in the ERD list. The EHMF may modify the ERD list, replacing each EAPI with the EA's edge resource description (CPU resources, storage resources, etc.). The EHMF may determine if the requested edge resources are available based on the ERD list. The EHMF may determine if there are sufficient available edge resources to satisfy the request by comparing total level of edge resources configured in an edge host against the level of those resources allocated or reserved or available to EAs.

If the ERD list includes EAs that are deployed across on several distributed edge hosts that a managed by separate EHMFs, the EHMF may transmit an Edge Application Modification request to each EHMF for their respects EAs in the ERD list. The EHMF may create a filtered ERD list with entries relevant for each EHMF or it may send the full ERD list.

If the EHMF determines that there are sufficient edge resources to satisfy the Edge Application Modification request, this procedure may continue with two options: option 1) Edge Host-driven in Steps 6-10, where the EHMF may modify the edge resources per the request and informs the ESMF; option 2) Edge System Management-driven in Steps 11-15, where the EHMF may validate with the ESMF before re-allocating edge resources. The selection between utilizing the Edge Host-driven option or the Edge System Management-driven option may be based on EHMF pre-configuration, EHMF-level policy, or Edge System policy.

If the EHMF determines there are insufficient edge resources, the EHMF may proceeds to step 16 of FIG. 10.

Referring to FIG. 10, option 1 (Edge Host driven), at step 6, the EHMF may issue requests to the Edge Host VI to modify edge resources as indicated in the ERD list or EAVPI from step 4 of FIG. 10. At step 7, the VI may update its edge resource allocations per the request in Step 6 and responds to the EHMF. Step 6 and step 7 may repeat for each EA and each edge resource in the ERD List. Additionally, the VI may respond, indicating failure and may include a failure cause; for example, if edge resource allocation fails in this step.

Referring to FIG. 10, option 1, at step 8, after the edge resources are modified (success response from step 7), the EHMF may transmit an Edge Application Descriptor Modification notification to the ESMF to inform it about the change of edge resources allocated in Steps 6 and 7. The notification may include an EHMF ID (e.g., identifier of the EHMF), EHMF security and trust credentials, and a modified EA descriptor list (which includes the updated ERDs). The updated ERDs may include information about the modified edge resources. An ERD may include a full and complete set of edge resource parameters or only the parameters impacted by modification. All omitted parameters are retained. As an alternative, the EHMF may send an ERD list (instead of EA descriptors) to the ESMF which may than modify the EA descriptors in Step 9. Additionally, if the VI indicates an edge resource allocation error (failure response from step 7), the EHMF proceeds to step 16 of FIG. 10.

Referring to FIG. 10, option 1, at step 9, using the modified EA descriptors with updated ERDs from step 8, the ESMF may updates its edge management objects, edge application instance descriptors and packages, and data stores with the new edge resource allocations to the impacted EA instances and edge resource availability on the impacted Edge Hosts. At this point, the EHMF and the ESMF may be consistent in terms of resource allocations. The ESMF may use the new edge resource allocation information in the ERDs when making edge system orchestration decisions, for example on where to deploy newly onboarded EAs to the Edge System on specific Edge Hosts. Additionally, the EHMF may adjust the ERD modifications based on information that it may have internally or may receive from an edge operations support system (OSS) or the edge application vertical provider. ERD modifications may satisfy the requests from the EA in step 2. If EHMF makes any ERD adjustment, it may provide the acknowledgement response in Step 10.

Referring to FIG. 10, option 1, at step 10, optionally, the ESMF may respond to the EHMF with an acknowledgement to the notification received in Step 8 of FIG. 10. If the ESMF adjusted any ERD modifications in Step 9, the ESMF may include adjusted ERDs in the impacted EA descriptors or in an ERD list. EHMF may repeat step 6 and step 7 based on an edge resource changes in the adjusted ERDs. If the EHMF does not receive this notification, it may retry the notification in Step 8. Alternatively, after a number of failed acknowledgements, the EHMF may restore the EAs to their previous edge resource allocations and notify them via the EAEF.

Referring to FIG. 10, option 2 (Edge System Management driven), at step 11, before adjusting edge resources with the VI, the EHMF may verify and may acquire approval from the ESMF for the EA modification. The EHMF may transmit an Edge Application Descriptor Modification request to the ESMF including information on the requested EA edge resource reallocation. The request may include an EHMF ID (e.g., identifier of the EHMF), EHMF security and trust credentials, and a modified EA descriptor list (which includes the requested updates to the EAs ERDs). The updated ERDs may include the edge resource modification information from step 4 of FIG. 10. An ERDs may include a full and complete set of edge resource parameters or only the parameters impacted by modification. All omitted parameters may be retained. As an alternative, the EHMF may send an ERD list (instead of EA descriptors) to the ESMF which may than modify the EA descriptors in Step 9.

Referring to FIG. 10, option 2, at step 12, using the modified EA descriptor list (with requested ERD changes) from step 11, the ESMF may verify the EHMF (security, trust, etc.) and may validate the ERD modifications requested. For example, the ESMF may check against any planned EA deployments to the affected edge hosts. If validated, the ESMF may update its edge management objects, edge application instance descriptors and packages, and data stores with the new resource allocations to the impacted EA instances and Edge Host resource availability. The ESMF may use the new edge resource allocation information in the ERDs when making edge system orchestration decisions, for example on where to deploy newly onboarded EAs to the Edge System on specific Edge Hosts. The ESMF may adjust the ERD modifications based on information that it may have internally or may receive from an edge operations support system (OSS) or the edge application vertical provider. ERD modifications must satisfy the requests from the EA in step 2 of FIG. 10.

Referring to FIG. 10, option 2, at step 13, the ESMF may transmit an Edge Application Modification response to the EHMF. The response may acknowledge the request received in step 11 and may include an indication of success (including any adjusted ERDs in a list or in the impacted EA descriptors) or failure. If the edge application modification failed in step 12, the response may include an error indication, may include a failure cause, and may include additional information regarding alternative edge resource availability for the EA(s) to make future modification requests. If the response includes an indication of failure, the EHMF may proceed to step 16 of FIG. 10.

Referring to FIG. 10, option 2, at step 14, the EHMF may issue requests to the Edge Host VI to modify edge resources as indicated in the ERD list from step 4 or adjusted as received in step 13. At step 15, the VI may update its edge resource allocations per the request in step 14 and responds to the EHMF.

Step 14 and step 15 of FIG. 10 may repeat for each EA and each edge resource in the ERD list. Additionally, if the VI indicates an edge resource allocation error (failure response from step 7), the EHMF may inform that ESMF of the failure (informing the reason). The ESMF may update its edge management objects, edge application instance descriptors and packages, and data stores accordingly.

Referring to FIG. 10, at step 16, the EHMF may transmit an Edge Application Modification response to the EAEF indicating as follows:
(i) Success case (from both Option 1 and Option 2): Edge Application Modification response may indicate successful completion with an ERMD informing the EAEF of the modified EA resource allocations, either as requested or adjusted.
(ii) Error case-edge resource allocation failure: Edge Application Modification response may indicate failed edge resource allocation by ESMF and may include any alternative edge resource information (e.g., as an ERMD) received from the ESMF.
(iii) Error case-insufficient edge resources: Edge Application Modification response may indicate insufficient edge resources available. The response may include information regarding what edge resources are available for reallocation to the requested EA(s) as an ERMD. The EA may use any edge resource availability information in the error response received from the EAEF to make a future Edge Application Modification request to better ensure success.
(iv) Error case-verification/validation failure (e.g., from step 4 of FIG. 10): If any validation fails in step 4, Edge Application Modification response may indicate validation failure.

Additionally, the EHMF may send an Edge Application Modification response indicating failure and may include a failure cause; for example, if the verification/validation failed in step 4.

Referring to FIG. 10, at step 17, the EAEF may inform the requesting EA on the Application Vertical Modification based on the received Edge Application Modification response, as follows:
(i) Edge Application Modification success response-edge resources modified: EAEF may transmit an Application Vertical Modification response indicating success that the edge resources are modified (e.g., as an ERMD) as requested from step 2 or adjusted (e.g., by the ESMF). Additionally, the EAEF may send an Edge Application Modification notification to all other EAs in the ERMD (i.e., besides the EA from Step 2) to inform each EA about their updated edge resources. As an alternative, the Edge Application Modification notification may be sent by the VI to the EAs.
(ii) Edge Application Modification error response indicating that edge resources not modified with alternate edge resource availability information: EAEF may transmit an Application Vertical Modification response indicating edge resource modification failure and may include any alternative edge resource availability information received from the EHMF. The EA may use the alternative edge resource availability information in the error response received from the EAEF to make a future Edge Application Modification request to better ensure success.
(iii) Edge Application Modification verification failure-EAEF may send an Application Vertical Modification response indicating verification/validation failure.

Additionally, the EAEF may send an Application Vertical Modification response indicating failure and may include a failure cause; for example, if the verification/validation failed in step 2 or the request in step 4 failed.

Referring to FIG. 10, at step 18, if Application Vertical Modification response indicates success, the EA(s) may utilize the modified edge resources to maintain or improve edge application vertical performance. For example, an XR rendering EA may use increased edge resources to render additional objects in a game, while increasing video resolution, and changing video compression levels.

If the Application Vertical Modification response indicated an error and provided alternative edge resource availability information, the EA may use the alternative edge resource availability information to make a future Edge Application Modification request to better ensure success.

In an embodiment, a method implemented in a first device (e.g. a first node/a first WTRU) comprising an Edge Host Management Function (EHMF), the method may comprise a first step wherein the first device may receive an edge Application (EA) Modification request from a second device (e.g., a second node/a second WTRU). The second device may comprise an Edge Application Enablement Function (EAEF).

The edge application modification request may contain any of a EAEF identity, a EAEF security and trust credentials, and an Edge Resource Modification Descriptor (ERMD). The ERMD may include an Edge Application Vertical Performance Index (EAVPI) or an Edge Resource Descriptor (ERD) list. In other words, the edge application modification request may include an overall edge application vertical EAVPI, that can be processed to identify the edge resource requirements for each EA within the edge application vertical. Alternatively, the edge application modification request may include a list of ERDs that include identities of EAs and their corresponding updated performance requirements for the edge resources (as an EA level EAPI or as a detailed edge resource description).

The method may comprise a second step wherein the first device may verify any of the EAEF identity, security credentials, and trust for the EAEF and the ERMD

On condition that the ERMD includes an EAVPI, the method may comprise a third step wherein the first device may transform the EAVPI into an ERD list

On condition that the ERMD includes an ERD list with EAPI, the method may comprise a fourth step wherein the first device may transform each EAPI into a detailed edge resource description

The method may comprise a fifth step wherein the first device may determine if there are sufficient edge resources to satisfy the Edge Application Modification request based on the ERD list and available edge resources on the edge host. Sufficient edge resources may be determined based on the comparing in total level of edge resources configured in an edge host against the level of those resources allocated or reserved or available to EAs (also known as available edge resources).

For each EA and ERD entry in the ERD list, the method may comprise a sixth step wherein the first device may transmit a resource allocation request to the second device (VI). This resource allocation request may be repeated for edge resource and EA in the ERD list.

The method may comprise a seventh step wherein the first device may generate an Edge App Descriptor Modification notification including any of an EHMF ID, EHMF credentials, and a modified set of Edge Application Descriptors for each ERD entry in the ERD list.

The method may comprise an eighth step wherein the first device may transmit the Edge App Descriptor Modification notification to a third device (e.g., third node, third WTRU). The third device may comprise an ESMF.

The method may comprise a nineth step wherein the first device may receive an Edge App Descriptor Modification acknowledgement from the third node, that may include modified Edge Application Descriptors. For each modified Edge Application Descriptor, the method may comprise a step wherein the first device may send a resource allocation request to the second device (VI).

The method may comprise a tenth step wherein the first device may transmit an Edge Application Modification response to the second device (EAEF), including a modified ERMD based on the modified Edge Application Descriptors.

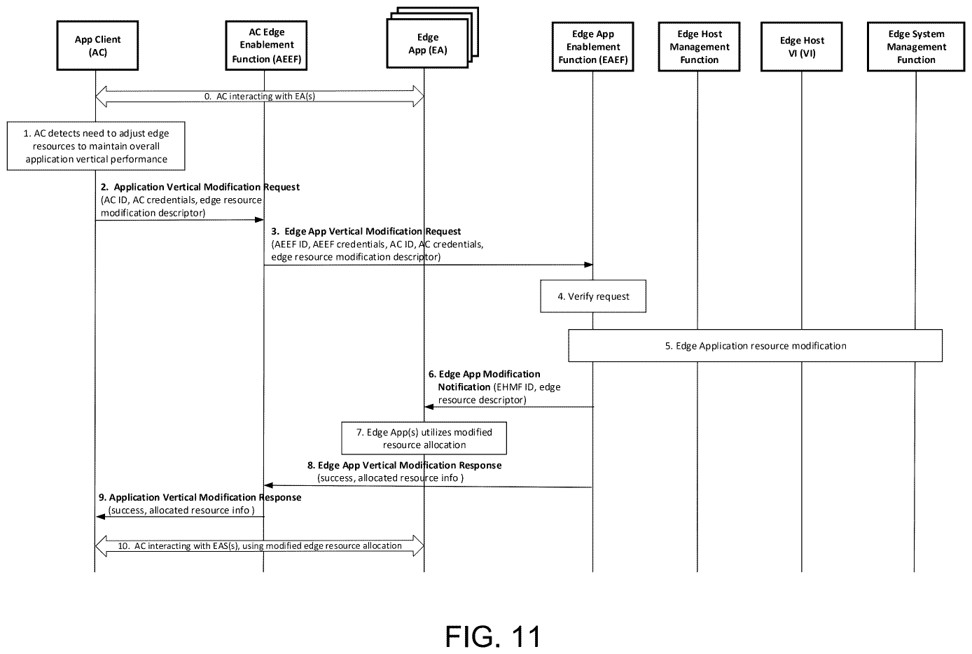

In an embodiment, an Application Client (AC) may determine the need to modify edge resources for one or more Edge Applications (EAs) within an application vertical, in order to maintain the sufficient performance. As depicted in FIG. 11, after an AC detects the need to adjust edge resources, the AC may request for edge modification in the edge system via an AC Edge Enablement Function (AEEF) described herein. The AEEF may interface with an EAEF to coordinate the modification of edge resources at an edge host level with the EHMF and host VI, and at an edge system level with the ESMF. Edge resources that may be modified and re-allocated for one or more EA(s) in the edge application vertical include CPU, memory, disk, storage, GPU, HW/FPGA, AIML, and other resources.

Referring to FIG. 11, at step 0, an edge application vertical may be deployed within the Edge System and may be composed of several EA instances that may be instantiated on one or more edge hosts, including device edge hosts. These EA instances may be of the same or different edge application types. One or more ACs may have discovered one or more EA(s) within the application vertical and are interacting in an application-specific manner.

Referring to FIG. 11, at step 1, an AC may detect a change in application vertical performance and the need to adjust edge resources within the edge application vertical. The AC may determine the need to either increase or decrease edge resources. For example, an XR game client may detect the need for an XR rendering EA to render more or less objects, to increase or decrease video resolution, to change video frame rates, to increase or decrease video compression, need to reduce power consumption to maintain battery level, etc., including combinations of all these conditions.

Referring to FIG. 11, at step 2, the AC may transmit an Application Vertical Modification request to the AC Edge Enablement Function (AEEF) to request an update to edge resources for the application vertical as determined in Step 1. The Application Vertical Modification request may include any of an AC ID (e.g., identifier of the requesting AC), AC security and trust credentials, and an ERMD described herein. The ERMD may include the edge resource modifications for each impacted EA determined in Step 1.

For example, the AC may send a request for an adjusted EAVPI for the edge application vertical. For example, an XR game display client may require a higher EAVPI to present additional XR objects with increased dynamics to a user with a higher video resolution and frame rate. This may require additional performance (including the need to additional edge resources) for an XR Rendering EA and for an XR Game Coordinator or Game Server EA. Conversely, an XR game display client may need a lower EAVPI if the number of XR objects or their needed quality is less. In turn, this lower performance index may enable the Edge System to reallocate edge resources to other EAs or edge application verticals.

For example, the AC may send a request for an ERD list with edge resource adjustments for several EAs in an edge application vertical. Using the same example, an XR rendering EA may need to render an additional XR objects with increased dynamics (resolution and frame rate). The ERD list may include an EAPI or an edge resource description such as: 1) XR render EA modification for additional GPU, response rate, and networking resources (increased bandwidth and reduced latency); 2) Game Coordinator EA modification for additional CPU resources and storage (since this EA is impacted by the XR rendering EA changes).

Referring to FIG. 11, at step 3, the AEEF may verify the Application Vertical Modification request received from step 2 of FIG. 11. The AEEF may verify the AC ID and security credentials to ensure the request is valid and that the AC has sufficient permissions. The AEEF may verify the trust index or level of the requesting AC, either directly or via the services of a Trust Management Function/Enabler.

If the Application Vertical Modification request is determined to be valid, the AEEF may transmit an Edge Application Vertical Modification request to the EAEF. The Edge Application Vertical Modification request may include any of an AEEF ID (e.g., identifier of the requesting AEEF), AEEF security and trust credentials, and any information from the Application Vertical Modification request received from the AC in step 2 of FIG. 11, including the ERMD. If the request from the AC in step 2 of FIG. 11 included an EAVPI, the AEEF may interpret the EAVPI and may translate it into an ERD list.

If the Application Vertical Modification request is determined to be invalid (including not trusted), the AEEF may reject the request, and the procedure may continue in step 9 of FIG. 11.

Referring to FIG. 11, at step 4, the EAEF may verify the Edge Application Vertical Modification request received from step 3 of FIG. 11. The EAEF may verify the AEEF ID and security credentials to ensure the request is valid and that the AEEF has sufficient permissions. The EAEF may verify the trust index or level of the requesting AEEF (and included EAs), either directly or via the services of a Trust Management Function/Enabler. The EAEF may verify the AC ID and AC security credentials to ensure the request is valid and that the AC has sufficient permissions. The EAEF may verify the trust index or level of the requesting AC, either directly or via the services of a Trust Management Function/Enabler.

If the Edge Application Modification request is determined to be invalid, the EAEF may reject the request, and the procedure continues in step 8 of FIG. 11.

Referring to FIG. 11, at step 5, the EAEF may request edge resource modifications by triggering steps 4 to 16 of FIG. 10.

Referring to FIG. 11, at step 6, the EAEF may transmit an Edge Application Modification notification to each EA instance with updated edge resources from Step 5 of FIG. 11. The Edge Application Modification notification may inform the EA(s) of their updated edge resources such as any of CPU resources, memory resources, storage resources, service dependencies, feature dependencies, latency requirements, response time/rate limits, GPU resources and limits, FPGA resources and limits, interface descriptors, and platform or virtualization accelerator requirements in an ERD or directly. As an alternative, the Edge Application Modification notification in this step may be sent by the VI to the EA.

Referring to FIG. 11, at step 7, each EA, that received an Edge Application Modification notification in step 6 of FIG. 11, may update its internal EA operation (e.g., an XR Rendering EA may rendering additional XR objects with increased quality, higher video resolution, and faster video framerate) using the updated edge resources obtained in the notification. Step 7 is asynchronous from step 8 and may happen afterward.

Referring to FIG. 11, at step 8, the EAEF may inform the requesting AEEF by sending it an Edge Application Vertical Modification response indicating (e.g., as an ERMD) that the edge resources are modified as requested from step 3 of FIG. 11 or adjusted in step 5 of FIG. 11. Additionally, the EHEF may send an Edge Application Vertical Modification response indicating failure and may include a failure cause; for example, if the verification/validation failed in step 4 of FIG. 11.

Referring to FIG. 11, at step 9, the EAEF may inform the requesting AC by sending it an Application Vertical Modification response indicating (e.g., as an ERMD) that the edge resources are modified as requested from step 2 of FIG. 11 or adjusted in step 5 of FIG. 11. Additionally, the AEEF may send an Application Vertical Modification response indicating failure and may include a failure cause; for example, if the verification/validation failed in step 2 of FIG. 11.

Referring to FIG. 11, at step 10, the AC may interact e.g., sends and receives data in an application-specific manner) with the one or more EA(s) within the application vertical. The EA(s) may provide the overall application-level performance expected by the AC, as determined in step 1 of FIG. 11.

In an embodiment, a method implemented in a first device (first node/first WTRU) comprising an AC edge enablement function, the method may comprise a first step wherein the first device may receive an Application Vertical Modification request from the first device (first node/first WTRU). The first device may comprise an Application Client. The Application Vertical Modification Request may contain any of an AC identity, AC credentials, and an Edge Resource Modification Descriptor (ERMD). The ERMD may include an EAVPI or an ERD list.

The method may comprise a second step wherein the first device may verify any of the AC identity, the AC credentials, and trust for the AC and ERMD.

On condition that the ERMD included an EAVPI, the method may comprise a third step wherein the first device may transform the EAVPI into an ERD list.

The method may comprise a fourth step wherein the first device may generate an Edge Application Vertical Modification request that includes any of an AEEF ID, AEEF credentials, AC ID, AC credentials, and an ERMD.

The method may comprise a fifth step wherein the first device may transmit the Edge Application Vertical Modification request to a second device (e.g., second node, second WTRU). The second device may comprise an EAEF.

The method may comprise a sixth step wherein the first device may receive an Edge Application Vertical Modification response from the second device that may include new or modified ERMD.

The method may comprise a seventh step wherein the first device may generate an Application Vertical Modification response with the ERMD.

The method may comprise an eighth step wherein the first device may transmit the Application Vertical Modification response to the Application Client (e.g., first device).

In an embodiment, an Edge Application (EA) may query an edge system to determine what level of edge resources may be available for run-time modification of an edge application or edge application vertical. Edge resources may include any of CPU, memory, disk, storage, GPU, HW/FPGA, AIML, and other resources. The EA may query for resources available for itself or other EA instances (e.g., EA(s) within an edge application vertical deployment).

Referring to FIG. 12, an edge application vertical may be deployed within the Edge System and may be composed of several EA instances that may be instantiated on one or more edge hosts, including device edge hosts. These EA instances may be of the same or different edge application types. At least one EA instance may have sufficient security credentials and trust to request edge resource queries with the edge system.

Referring to FIG. 12, at step 1, an EA may need to learn what edge resources may be available in the edge system for run-time modification. For example, the EA may be detecting or predicting future performance changes that would require edge resource changes (e.g., for a XR rendering EA to generate additional XR objects with higher quality or dynamics).

The EA may transmit an Edge Application Resource Query request to the EAEF. The Edge Application Resource Query request may include any of EA ID (e.g., identifier of the requesting EA), EA security and trust credentials, and an Edge Resource Query Descriptor (ERQD) described herein. The ERQD may include the list of edge resources to query for EA(s) of interest.

For example, the EA may send a request for a higher or adjusted EAVPI for the edge application vertical. For example, an XR rendering EA may determine if edge resources are available for an EAVPI that will enable it to render additional XR objects with increased dynamics for a user with a higher video resolution and frame rate. Conversely, an XR render EA may want to a lower EAVPI if the number of XR objects it needs to create, or their needed quality is less.

For example, an ERD list with edge resource may query for several EAs in an edge application vertical. Using the same example, an XR rendering EA may want to assess edge resource availability to render additional XR objects with increased dynamics (resolution and frame rate). The ERD list may include: 1) XR render EA edge resource query for additional GPU, response rate, and networking resources (increased bandwidth and reduced latency); 2) Game Coordinator EA edge resource query for additional CPU resources and storage (since this EA is impacted by the XR rendering EA changes).

Referring to FIG. 12, at step 2, the EAEF may verify the Edge Application Resource Query request received from step 1 of FIG. 12. The EAEF may verify the EA ID and security credentials to ensure that the request is valid, and that the EA has sufficient permissions. The EAEF may verify the trust index or level of the requesting EA, either directly or via the services of a Trust Management Function/Enabler.

On condition that the Edge Application Resource Query request is determined to be invalid (including not trusted), the EAEF may reject the Edge Application Resource Query request, and the procedure continues in step 6 of FIG. 12.

Referring to FIG. 12, at step 3, the EAEF may check the availability of edge resources with the EHMF. On condition that the Edge Application Resource Query request received from the EA includes an ERQD with an EAVPI, the EAEF may interpret the EAVPI and translate it into an ERD list. On condition that the received or resulting ERD list includes EAVIs, the EAEF may interpret the EAVIs and translate them into edge resource descriptions.

The EAEF may transmit an Edge Application Resource Query request to the EHMF. The request may include any of an EAEF ID (e.g., identifier of the requesting EAEF), EAEF security and trust credentials, an ERD list and any information from the Edge Application Resource Query request received from the EA. For example, the request may include the ERD list obtained in the Edge Application Resource Query request received from the EA, or an ERD list generated from the EAVPI received in the Edge Application Resource Query request. The ERD list may include the edge resource descriptions or an EAPI to be queried for each indicated EA. An ERD entry may include a complete set of edge resource parameters. Alternatively, a descriptor entry may include only the parameters requested for query. If all parameters are omitted, then all parameters may be queried. In another example, the EAEF may forward the received EAVPI to the EHMF in place of the ERD list.

Referring to FIG. 12, at step 4, on condition that the request from the EAEF in step 3 of FIG. 12 included an EAVPI, the EHMF may generate an ERD list based on the EAVPI information. If the generated or received ERD list includes EAPIs, the EHMF may process each EAPIs to determine the need edge resources for that EAPI. The EHMF may update the ERD list with the resulting edge resource descriptions.

Next, EHMF may use the ERD list to determine if the queried edge resources are available for reallocation.

The EHMF may check for its local edge resource availability against all deployed EA instances. The EHMF may also consult with the ESMF or other EHMF instances for other edge hosts (including device edge hosts).

Referring to FIG. 12, at step 5, the EHMF may transmit an Edge Application Resource Query response to the EAEF, indicating the level of edge resources available for run-time modification.

Referring to FIG. 12, at step 6, in turn, the EAEF may transmit an Edge Application Resource Query response to the requesting EA from step 1, indicating the level of edge resources available for run-time modification.

Additionally, the EAEF may transmit an Edge Application Resource Query response indicating failure and may include a failure cause; for example, if the verification/validation failed in step 2 of FIG. 12.

Referring to FIG. 12, at step 7, with the edge resource availability information from step 6 of FIG. 12, the EA may request for edge resource run-time re-allocation using the Edge Application Initiated Edge Resource Run-time Modification procedure, described in the procedure of FIG. 10.

In an embodiment, an Application Client (AC) may query an edge system to determine what level of edge resources may be available for run-time modification of an edge application or edge application vertical. Edge resources may include any of CPU, memory, disk, storage, GPU, HW/FPGA, AI/ML, and other resources. The AC may query for resources available for a single EA instance or for a group of EAs within an edge application vertical deployment.

This procedure may be similar to the EA initiated edge resource query, described in the procedure of FIG. 12, with modifications needed for an AC.

An edge application vertical may be deployed within the Edge System and may be composed of several EA instances that may be instantiated on one or more edge hosts, including device edge hosts. These EA instances may be of the same or different edge application types. An AC may be utilizing one or more EAs within the edge application vertical, including communicating directly at an application level. The AC may have sufficient security credentials and trust to request edge resource queries with the edge system.

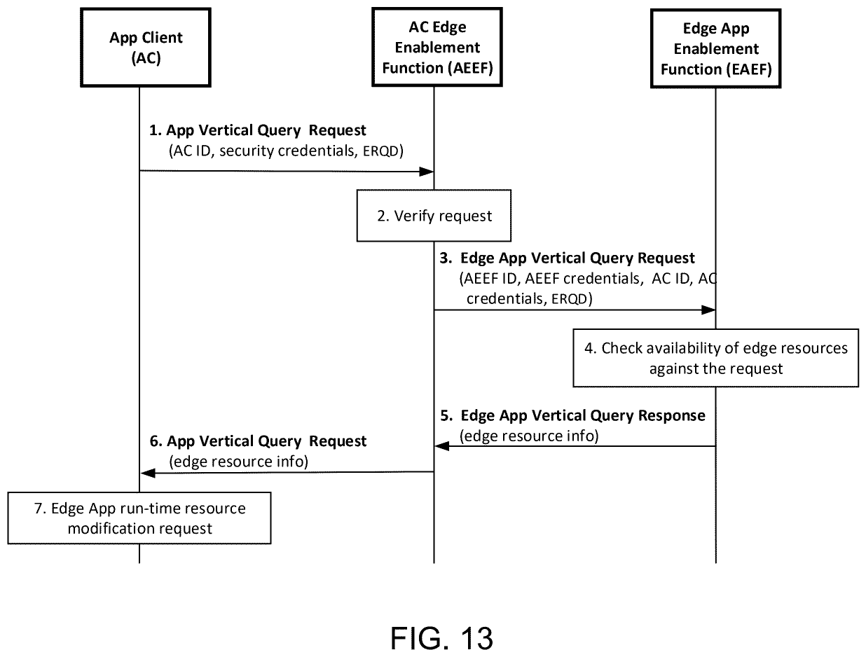

Referring to FIG. 13, at step 1, an AC may need to learn what edge resources may be available in the edge system for run-time modification. For example, the AC may be detecting or predicting future performance changes that would require edge resource changes (e.g., a XR display client AC determines that additional XR objects need to be rendered by one or more EAs with higher quality or dynamics).

The AC may transmit an Application Vertical Resource Query request to the AEEF. The request may include any of an AC ID (e.g., identifier of the requesting AC), AC security and trust credentials, and an Edge Resource Query Descriptor (ERQD).

Referring to FIG. 13, at step 2, the AEEF may verify the Application Vertical Resource Query request received from step 1 of FIG. 13. The AEEF may verify the AC ID and security credentials to ensure that the request is valid, and that the AC has sufficient permissions. The AEEF may verify the trust index or level of the requesting AC, either directly or via the services of a Trust Management Function/Enabler.

If the Application Vertical Resource Query request received from the AC includes an ERQD with an EAVPI, the AEEF may interpret the EAVPI and translate it into an ERD list in the ERQD. If the Application Vertical Resource Query request is determined to be invalid, the AEEF may reject the request, and the procedure may continue in step 6 of FIG. 13.

Referring to FIG. 13, at step 3, the AEEF may check the availability of edge resources with the EAEF. The AEEF may transmit an Edge Application Vertical Resource Query request to the EAEF. The request may include any of an AEEF ID (e.g., identifier of the requesting AEEF), AEEF security and trust credentials, an ERQD (EAVPI or ERD list), and any information from the Application Vertical Resource Query request received from the AC. For example, the request may include the ERD list obtained in the Application Vertical Resource Query request received from the AC, or an ERD list generated from the EAVPI received in the Edge Application Vertical Resource Query request. The ERD list may include the edge resources to be queried for each indicated EA. An ERD entry may include a complete set of edge resource parameters or an EAPI. Alternatively, a descriptor entry may include only the parameters requested for query. If all parameters are omitted, then all parameters may be queried. In another example, the AEEF may forward the received EAVPI to the EAEF in place of the ERD list.

Referring to FIG. 13, at step 4, the EAEF may determine if the queried edge resources are available for run-time reallocation, for example by using steps 2 through step 5 of FIG. 12.

Referring to FIG. 13, at step 5, the EAEF may transmit an Edge Application Vertical Resource Query response to the AEEF, indicating the level of edge resources available for run-time modification.

Referring to FIG. 13, at step 6, in turn, the AEEF may transmit an Application Vertical Resource Query response to the requesting AC from step 1 of FIG. 13, indicating the level of edge resources available for run-time modification.

Additionally, the AEEF may transmit an Application Vertical Resource Query response indicating failure and may include a failure cause; for example, if the verification/validation failed in step 2 of FIG. 13 or if the EAEF indicated an error in step 5 of FIG. 13.

Referring to FIG. 13, at step 7, with the edge resource availability information from Step 6, the AC may request for edge resource run-time re-allocation allocation using the Application Client Initiated Edge Resource Run-time Modification procedure, described in the procedure of FIG. 11. In other words, the AC may decide to initiate the Edge Resource Run-time Modification procedure of FIG. 11 based on the edge resource availability information.

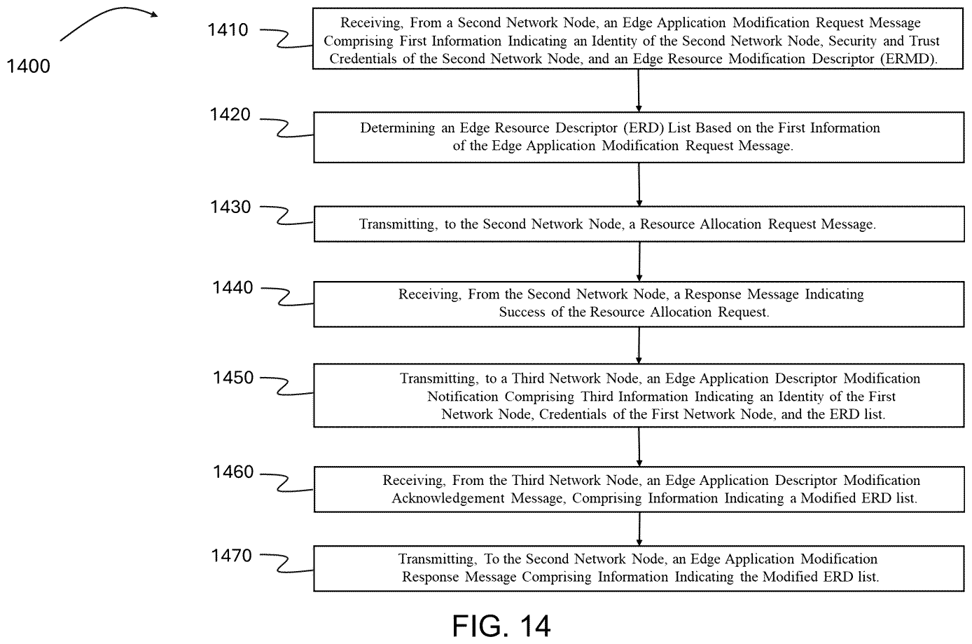

Referring to FIG. 14, in an embodiment, a method 1400, implemented in a first network node, may comprise a step wherein the first network node may receive 1410, from a second network node, an (e.g., edge) application modification request message comprising first information indicating an identity of the second network node, security and trust credentials of the second network node, and an (e.g., edge) resource modification descriptor (ERMD). The ERMD may comprise information indicating an edge application vertical performance index. The method 1400 may comprise a step wherein the first network node may determine 1420 an (e.g., edge) resource descriptor (ERD) list based on the first information of the (e.g., edge) application modification request message. The ERD list may comprise at least one ERD entry including an (e.g., edge) application performance index. The method 1400 may comprise a step wherein the first network node may transmit 1430, to the second network node, a resource allocation request message. The method 1400 may comprise a step wherein the first network node may receive 1440, from the second network node, a response message indicating success of the resource allocation request. The method 1400 may comprise a step wherein the first network node may transmit 1450, to a third network node, an (e.g., edge) application descriptor modification notification comprising second information indicating an identity of the first network node, credentials of the first network node, and the ERD list. The method 1400 may comprise a step wherein the first network node may receive 1460, from the third network node, an (e.g., edge) application descriptor modification acknowledgement message, comprising third information indicating a modified ERD list; and a step wherein the first network node may transmit 1470, to the second network node, an (e.g., edge) application modification response message, comprising fourth information indicating the modified ERD list.

The first network node may be a first edge device or a first wireless transmit/receive unit (WTRU). The second network node may be a second edge device or a second WTRU. The third network node may be a third edge device or a third WTRU.

The first network node may comprise an (e.g., edge) host management function. The second network node may comprise an (e.g., edge) application enablement function. The third network node may comprise a (e.g., edge) system management function.

The method 1400 may comprise a step wherein the first network node may determine if there are sufficient edge resources to satisfy the edge application modification request based on the ERD list and based on available edge resources for the edge application on the second network node; and a step wherein the first network node may transmit, to the second network node, the resource allocation request message on condition that are sufficient edge resources to satisfy the (e.g., edge) application modification request. The sufficient edge resources may be determined based on the comparing in total level of edge resources configured in the second network node against the level of those resources available for the edge application on the second network node.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method, implemented in a first network node, the method comprising
receiving, from a second network node, an edge application modification request message comprising first information indicating an identity of the second network node, security and trust credentials of the second network node, and an edge resource modification descriptor (ERMD);
determining an edge resource descriptor (ERD) list based on the first information of the edge application modification request message;
transmitting, to the second network node, a resource allocation request message;
receiving, from the second network node, a response message indicating success of the resource allocation request;
transmitting, to a third network node, an edge application descriptor modification notification comprising second information indicating an identity of the first network node, credentials of the first network node, and the ERD list;
receiving, from the third network node, an edge application descriptor modification acknowledgement message, comprising third information indicating a modified ERD list; and
transmitting, to the second network node, an edge application modification response message comprising fourth information indicating the modified ERD list.

2. The method of claim 1, wherein the first network node comprises an edge Host Management Function.

3. The method of claim 1, wherein the second network node comprises an edge Application Enablement Function.

4. The method of claim 1, wherein the third network node comprises an edge System Management Function.

5. The method of claim 1, wherein the ERD list comprises at least one ERD entry including an edge application performance index.

6. The method of claim 1, wherein the ERMD comprises fifth information indicating an edge application vertical performance index.

7. The method of claim 1, comprising
determining if there are sufficient edge resources to satisfy the edge application modification request based on the ERD list and based on available edge resources for the edge application on the second network node; and
transmitting, to the second network node, the resource allocation request message on condition that are sufficient edge resources to satisfy the edge application modification request.

8. The method of claim 7, wherein the sufficient edge resources are determined based on the comparing in total level of edge resources configured in the second network node against the level of those resources available for the edge application on the second network node.

9. A first network node, comprising a processor, a transceiver, and a memory which are configured to:
receive, from a second network node, an edge application modification request message comprising first information indicating an identity of the second network node, security and trust credentials of the second network node, and an edge resource modification descriptor (ERMD),
determine an edge resource descriptor (ERD) list based on the information of the edge application modification request message,
transmit, to the second network node, a resource allocation request message,
receive, from the second network node, a response message indicating success of the resource allocation request,
transmit, to a third network node, an edge application descriptor modification notification comprising second information indicating an identity of the first network node, credentials of the first network node, and the edge resource descriptor list,
receive, from the third network node, an edge application descriptor modification acknowledgement message, comprising third information indicating a modified ERD list, and
transmit, to the second network node, an edge application modification response message comprising fourth information indicating the modified ERD list.

10. The first network node of claim 9, wherein the first network node comprises an edge Host Management Function (EHMF).

11. The first network node of claim 9, wherein the second network node comprises an edge Application Enablement Function (EAEF).

12. The first network node of claim 9, wherein the third network node comprises an edge System Management Function (ESMF).

13. The first network node of claim 9, wherein the ERD list comprises at least one ERD entry including an edge application performance index.

14. The first network node of claim 9, wherein the ERMD comprises fifth information indicating an edge application vertical performance index (EAVPI).

15. The first network node of claim 9, wherein the processor, the transceiver, and the memory are configured to:
determine if there are sufficient edge resources to satisfy the edge application modification request based on the ERD list and based on available edge resources for the edge application on the second network node, and
transmit, to the second network node, the resource allocation request message on condition that are sufficient edge resources to satisfy the edge application modification request.

16. The first network node of claim 15, wherein the sufficient edge resources are determined based on the comparing in total level of edge resources configured in the second network node against the level of those resources available for the edge application on the second network node.
